(19) United States
(12) Patent Application Publication
(10) Pub. No.: US 2013/0044179 A1
(43) Pub. Date: Feb. 21, 2013

(54) METHOD AND TERMINAL FOR LEAVING VIDEO MESSAGES

(71) Applicant: Tao Peng, Shenzhen City (CN)

(72) Inventor: Tao Peng, Shenzhen City (CN)

(73) Assignee: ZTE Corporation, Shenzhen City (CN)

(21) Appl. No.: 13/520,625

(22) PCT Filed: Jan. 5, 2011
(86) PCT No.: PCT/CN2011/070040

§ 371 Date: Jul. 5, 2012

(30) Foreign Application Priority Data
May 7, 2010 (CN) 201010171118.2

(51) Int. Cl. H04N 7/14

(52) U.S. Cl. 348/14.06; 348/E07.077

(57) ABSTRACT

The present invention discloses a terminal for leaving video messages, which comprises a video message setting module, a video message management module, a video reception and storage module and a call control module. The video message setting module is configured to: configure a video message function; the video message management module is configured to: manage video message files in the video message storage medium; the video reception and storage module is configured to: receive and store both audio and video information of calling party; the call control module is configured to: control the entire working process of leaving a video message, and to start the video message function according to the configuration parameters when a video call arrives. The present invention also discloses a method for leaving messages on a terminal.

### TECHNICAL FIELD

The present invention relates to the communication technical field, and more specifically, to a method and a terminal for leaving video messages.

### BACKGROUND OF THE RELATED ART

With the development of the mobile communication technology, video calls have become increasingly popular. The video call service is a point-to-point video communication service, and it can take advantage of a telecommunication network to perform a two-way transmission of images and voice signals of two parties of a call in real-time.

If a calling party would like to make a video call to his/her friends and relatives, to share a beautiful scene around him/her as well as his/her joy, however a called party cannot answer the video call for a variety of reasons, the calling party can only hang up and the scene and the joy have gone at this time. It greatly reduces the user satisfaction, and affects the promotion and usage of the video call service.

### SUMMARY OF THE INVENTION

The purpose of the present invention is to introduce a method and a terminal for leaving video messages, so as to solve the problem that there is no video message function in the existing telecommunication service, and to make up for the deficiency of not supporting the video message in the existing communication network.

In order to achieve the above purpose, the present invention provides a terminal for leaving video messages, which comprises a video message setting module, a video message management module, a video reception and storage module, and a call control module;

the video message setting module is configured to: configure a video message function;

the video message management module is configured to: manage video message files in a video message storage medium;

the video reception and storage module is configured to: receive and store both audio and video information of a calling party;

the call control module is configured to: control a entire working process of leaving a video message, and to start the video message function according to configuration parameters when a video call arrives.

The video message function configured by the video message setting module comprises at least one of the following: carrying out configuration to start the video message function or to stop the video message function; configuring a video prompt file which is transmitted to the calling party and comprises a prompt file during a video message working process as well as a prompt file when the video message times out; configuring different video prompts used by different call numbers; and configuring a length of time for limiting a video message.

The video message management module is further configured to: support a deletion operation and play operation of the video message; and to associate the video messages with call records, so as to find one or a plurality of corresponding video messages through the call records.

The terminal for leaving video messages further comprises a preset message transmission module, which is configured to: transmit prompt information to the calling party during video message working process.

The terminal for leaving video messages further comprises a video message work indication module, and the video message work indication module is configured to: display a video message working status, which comprises prompt information of being in the video message working process and prompt information of having a new video message, on an interface of a called party.

The terminal for leaving video messages further comprises a message timing module, which is configured to: perform timing on the video message.

In order to achieve the aforementioned purpose, the present invention also provides a method for leaving video messages on a terminal, and the method comprises:

performing a video message configuration on a video terminal; and

receiving and storing content of a video call in a storage medium of a called terminal, when the video terminal detects the video call coming in.

The step of performing a video message configuration on a video terminal comprises: the video terminal opens a video message setting module to perform the video message configuration, wherein, the video message configuration comprises at least one of the followings: configuring whether to start the video message or not; carrying out configuration to start up for all incoming calls, a group of the incoming calls, a part of the incoming calls, or a certain incoming call number; carrying out configuration to start up for all incoming calls, a group of the incoming calls, a part of the incoming calls, or a certain incoming call number during a certain period of time; carrying out configuration to start up immediately when a call comes in, or to delay a period of time to start up when the video terminal doesn't answer proactively; configuring a prompt file of starting the video message and a prompt audio and video file when message time expires; configuring a maximum time length of a message; configuring whether to store in a mobile phone's own storage or to store in an extended storage card.

When the terminal has a call control module, the method further comprises: the call control module detects the video call, and starts a video message function when the video call comes in and preset conditions are all met.

The method further comprises: the call control module transmits a message to the video reception and storage module of the terminal to store an audio and video file, when detecting that the call ends.

In summary, with the aforementioned technical scheme, a calling party can store video call content of a transmitting side into a terminal of the opposite side for the opposite side that cannot answer the video call in time due to various reasons, so as to wait for the user of the opposite side to view the content in the future, thus not missing the exciting video of the transmitting side, and also achieving the video message function.

### BRIEF DESCRIPTION OF DRAWINGS

FIG. 1 is a structural schematic diagram of functional modules of a terminal for leaving video messages in accordance with an embodiment of the present invention;

FIG. 2 is an entire flow chart of a video message working process in accordance with an embodiment of the present invention;

FIG. 3 is a detailed flow chart for a called terminal to start the video message in accordance with an embodiment of the present invention;

FIG. 4 is a flow chart of performing video messages after starting a video message function, in accordance with an embodiment of the present invention.

### PREFERRED EMBODIMENTS OF THE PRESENT INVENTION

The present invention provides a method for leaving a video message and a terminal thereof, so as to make up for the deficiency of not supporting the video message in the existing communication network. Video call content of a transmitting side can be stored into a terminal of the opposite side for the opposite side who cannot answer the video call in time due to various reasons, so as to wait for the user of the opposite side to view the content in the future, thus not missing the exciting video of the transmitting side, and also achieving the video message function.

The technical scheme of the present invention will be illustrated in detail in combination with specific embodiments and accompanying drawings hereinafter. It should be noted that the embodiments of the present invention and the characteristics of the embodiments can be in any combination with each other, without conflict.

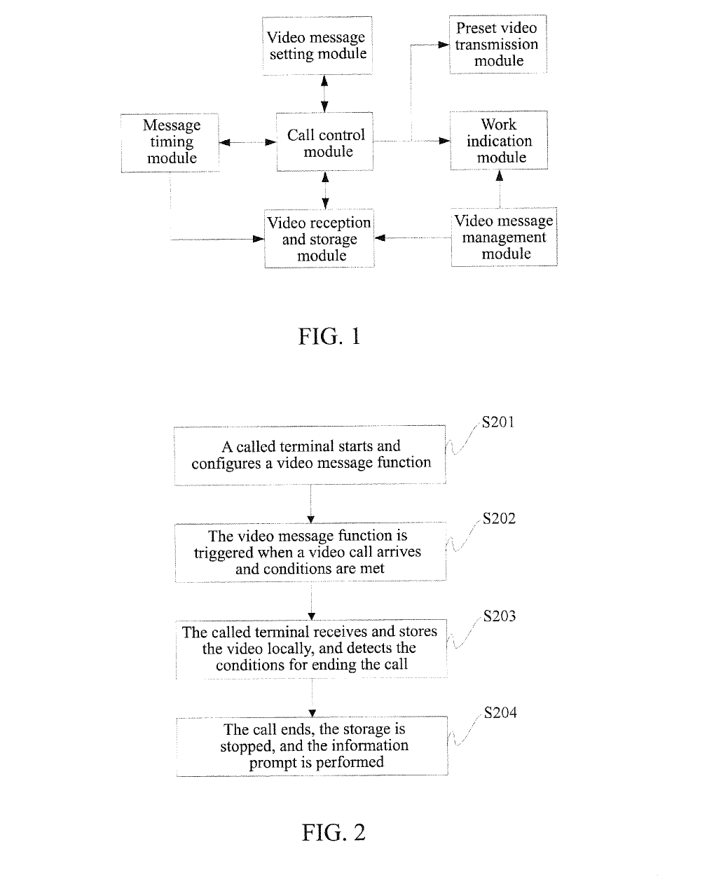

As shown in FIG. 1, the terminal for leaving video messages of the embodiment comprises the following modules of: a video message setting module, a preset video transmission module, a video message work indication module, a video message management module, a video reception and storage module, a message timing module and a call control module.

Wherein, the video message setting module is configured: to configure a video message function, wherein starting the video message function or stopping the video message function can be configured; if the video message function is started, it can be configured whether to start the video message function at once or to configure a period of delay time to start the video message function, after a video call arrives; a video prompt file sent to a calling party is configured, and the video prompt file comprises the configurations of two video prompt files, that is, a prompt file during a video message working process as well as a prompt file when the video message times out; it can be configured that different video prompts are used by different call numbers; and a length of time for limiting a video message is configured.

Wherein, the preset video transmission module is configured: to transmit the prompt information to the calling party during the video message working process, to indicate that a called party is performing the video message.

Wherein, the video message work indication module is configured: to display a video message working status, which comprises the prompt information of being in the video message working process and having a new video message and so on, on an interface of the called party. Wherein, the video message management module is configured: to manage video message files during the video message process. Operations such as deletion, play and so on of the video message are supported; and the video messages are associated with call records, so that the corresponding video messages can be found through the call records.

Wherein, the video reception and storage module is configured: to receive and store both audio and video information of the calling party.

Wherein, the message timing module is configured: to perform timing on the video message.

Wherein, the call control module is configured: to control the entire working process of leaving a video message, including starting the video message function according to the preset parameters, when a video call arrives. The calling party and the called party are prompted during the video message process; and the video message of the calling party is stored at the end of the call.

Especially, the wireless communication terminal mentioned in the present invention can be a mobile phone, and alternatively it can be composed of a host and a wireless communication access terminal (such as a wireless data card and a wireless communication module and so on). The embodiment is only illustrated for the mobile phone.

FIG. 2 is a step schematic diagram of a method for leaving messages on a terminal in accordance with an embodiment of the present invention, and as shown in FIG. 2, the method comprises the following steps.

In step S201, the called party opens the video message setting module on the mobile phone to perform configurations.

Wherein, whether to start the video message or not can be configured; starting up for all incoming calls, a group of the incoming calls, a part of the incoming calls, or a certain incoming call number can be configured; starting up for the aforementioned calls during a certain period of time; the video message function can be configured to start immediately when a call comes in, or to delay a period of time to start when the called party doesn't answer proactively; the prompt file of starting the video message as well as a prompt audio and video file when the message time expires can be configured; the maximum time length of a message can be configured; whether to store in a mobile phone's own storage or to store in an extended storage card can be configured.

In the embodiment, the video message function is configured to be started; starting up for the number 12345678 is configured; starting up from 8:00 to 10:00 in the morning is configured; staring the video message function without answering a incoming call for 10 seconds is configured; the maximum time length of a message is configured to be two minutes; and storing in an extended TF card is configured.

In step S202, the call control module of the called terminal detects video calls, and starts the video message function when a video call arrives and the preset conditions are all met. At the same time, the call control module invokes the preset video transmission module to transmit preset prompt information to the calling party, to prompt the calling party to leave a video message; it invokes the video message work indication module to indicate that the video message of the called party is in process; and it starts the message timing module to perform timing.

Wherein, the prompt information of being recorded, which is transmitted by the preset video transmission module to the calling party, is the prompt information preset by the video message setting module.

In step S203, the video reception and storage module receives and stores the video message of the caller. The call control module detects whether the call process ends or not, and the message timing module detects whether the message times out or not. If the above conditions are met, proceed to step S204.

Wherein, the time threshold of the message timing module is the time length preset in the video message setting module.

Wherein, the message timing module sends a timeout message to the call control module when detecting that the time threshold of the message is met;

wherein, if the message times out, the call control module invokes the preset video transmission module to transmit a prompt to the calling party, and ends the call within the limited time;

in the embodiment, it is configured that the call is ended after a timeout for 10 seconds;

wherein, during the video message process, the called party withdraws from recording the video message to transmit the current audio and video to the calling party if the called party needs to answer the video call, and both parties make the video call.

In step 204, the call ends, and the video message is stopped. The call control module transmits a message to the video reception and storage module to store the audio and video file, when detecting the end of call; the video message management module makes the video message correspond to the call record, and invokes the video message indication module to prompt the information that there is one new video message to user at the same time.

In particular, the prompt information transmitted to the calling party can be a video, audio and picture.

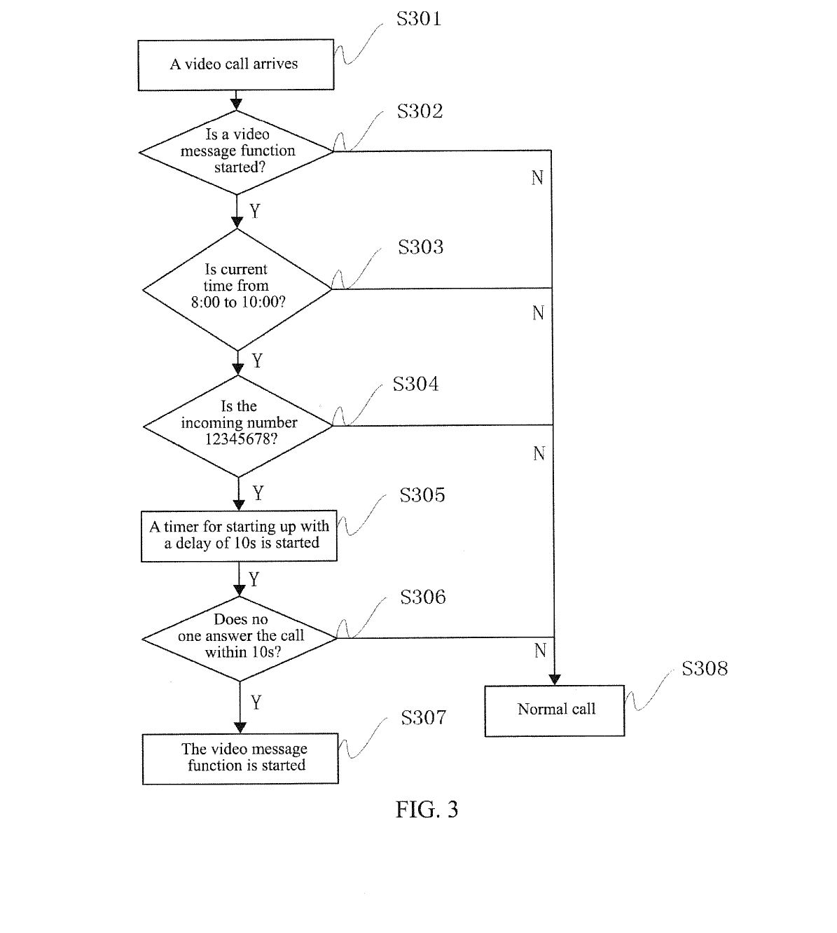

FIG. 3 shows a detailed flow chart for a called terminal to start a video message function, and comprises the following steps.

In step S301, a video call arrives;

in step S302, it is judged whether a video message function is configured to be started or not. If not started, skip to step S308; otherwise, proceed to step S303;

in step S303, it is judged whether the time is from 8:00 to 10:00 or not when the call arrives. If not, skip to step S308; if yes, proceed to step S304;

in step S304, it is judged whether the incoming call number is 12345678 or not. If not, skip to step S308; if yes, proceed to step S305;

in step S305, a timer for starting up with a delay is started;

in step S306, it is judged whether the called party answers the call proactively within 10 seconds. If yes, skip to step S308; otherwise, proceed to step S307;

in step S307, the video message function is started;

in step S308, the call is performed normally.

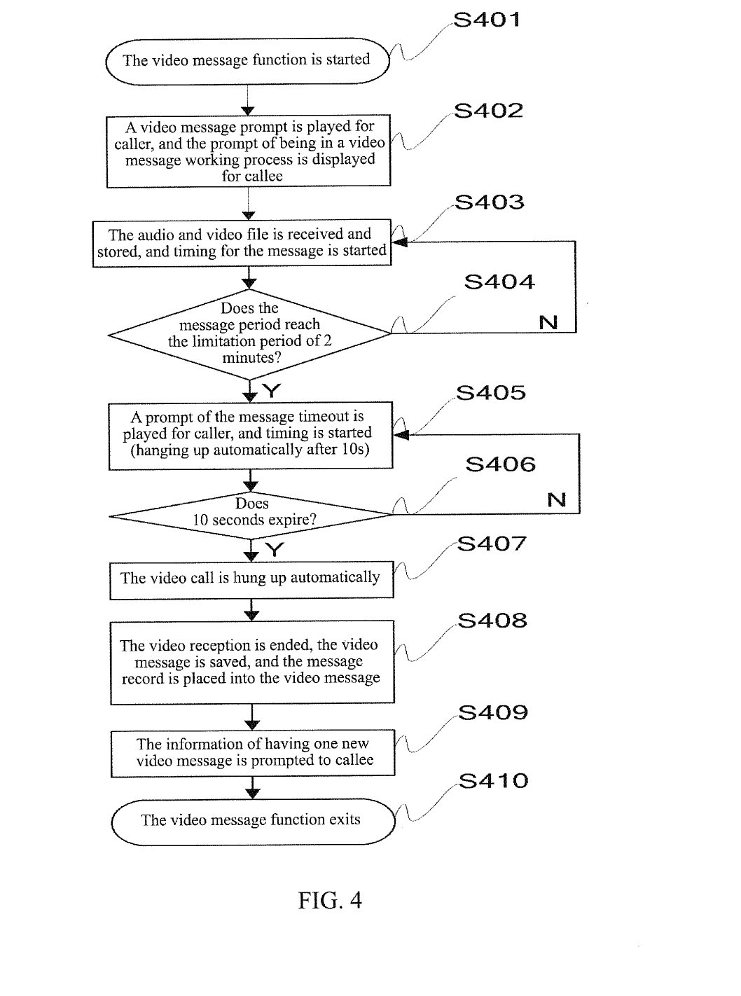

FIG. 4 shows a flow chart of performing video messages after starting a video message function in accordance with an embodiment of the present invention, and comprises following steps.

In step S401, the video message function is started;

in step S402, a video message prompt is played for the caller, and the prompt of being in a video message working process is displayed on an interface of the called terminal;

in step S403, the terminal receives and stores the audio and video file, and performs timing on the message;

in step S404, it is judged whether the message time reaches the preset limitation of 2 minutes. If not, return to step S403; otherwise, proceed to step S405;

in step S405, a prompt of message timeout is played for the caller, and timing is started;

in step S406, it is judged whether 10 seconds expires. If no, return to step S405; otherwise, proceed to step S407;

in step S407, the terminal hangs up the video call automatically;

in step S408, the video reception is ended, the video message is saved, and the message record is placed into the video message;

in step S409, the information of having one new video message is prompted to callee;

in step S410, the video message function exits.

In particular, the process will skip to step S408 immediately, if either the called party or the calling party hangs up to terminate the video call during the stage from step S401 to step S408.

In summary, the embodiments of the present invention provide a method for implementing a video message and a working process, so as to improve the application scope of a video call as well as the user satisfaction.

The terminal for leaving video messages and the method for leaving video messages on the terminal described by the present invention make the applications of video calls on terminals richer and more convenient. The present invention solves the problem that there is no video message function in the existing telecommunication service. Adopting the present invention, a calling party can leave a video message for a called party in the case that no one answers the video call or it is inconvenient for the called party to answer the video call, and the called party can store the video message information locally, including audio as well as video. Furthermore the video message can be played back for unlimited times at any time. Thus the user satisfaction of the video call is greatly improved.

Those skilled in the technical field should understand that all or parts of steps of the aforementioned method can be completed by programs instructing the related hardware, and the programs can be stored in a computer readable storage medium, such as a read-only memory, a disk, or a CD-ROM and so on. Alternatively, all or parts of steps of the aforementioned embodiments can be implemented with one or more integrated circuits. Correspondingly, each module or unit in the aforementioned embodiments can be implemented in the form of hardware, as well as software functional modules. The present invention is not limited to any specific forms of combinations of hardware and software.

Of course, the present invention also has a plurality of embodiments, and those skilled in the field should make various corresponding modifications and variations according to the present invention without departing from the spirit and essence of the present invention, while all modifications, equivalents and improvements which are made within the spirit and principle of the present invention, should be included in the protection scope of the present invention.

### INDUSTRIAL APPLICABILITY

The terminal for leaving video messages and the method for leaving video messages on the terminal described by the present invention make the applications of video calls on terminals richer and more convenient. The present invention solves the problem that there is no video message function in the existing telecommunication service. Adopting the present invention, a calling party can leave a video message for a called party in the case that no one answers the video call or it is inconvenient for the called party to answer the video call, and the called party can store the video message information locally, including audio as well as video. Furthermore the video message can be played back for unlimited times at any time. Thus the user satisfaction of the video call is greatly improved.

What is claimed is:

1. A terminal for leaving video messages, comprising a video message setting module, a video message management module, a video reception and storage module and a call control module;
the video message setting module being configured to: configure a video message function;
the video message management module being configured to: manage video message files in a video message storage medium;
the video reception and storage module being configured to: receive and store both audio and video information of a calling party;
the call control module being configured to: control a entire working process of leaving a video message, and to start the video message function according to configuration parameters when a video call arrives.

2. The terminal for leaving video messages of claim 1, wherein: the video message function configured by the video message setting module comprises at least one of following: carrying out configuration to start the video message function or to stop the video message function; configuring a video prompt file which is transmitted to the calling party and comprises a prompt file during a video message working process and a prompt file when the video message times out; configuring different video prompts used by different call numbers; and configuring a length of time for limiting the video message.

3. The terminal for leaving video messages of claim 1, wherein: the video message management module is further configured to: support a deletion operation and play operation of the video message; and to associate the video messages with call records, so as to find one or a plurality of corresponding video messages through the call records.

4. The terminal for leaving video messages of claim 1, wherein: the terminal for leaving video messages further comprises a preset message transmission module, which is configured to: transmit prompt information to the calling party during a video message working process.

5. The terminal for leaving video messages of claim 1, wherein: the terminal for leaving video messages further comprises a video message work indication module, and the video message work indication module is configured to: display a video message working status, which comprises prompt information of being in a video message working process and prompt information of having a new video message, on an interface of a called party.

6. The terminal for leaving video messages of claim 1, wherein: the terminal for leaving video messages further comprises a message timing module, which is configured to: perform timing on the video message.

7. A method for leaving video messages on a terminal, comprising:
performing a video message configuration on a video terminal; and
receiving and storing content of a video call in a storage medium of a called terminal when the video terminal detects the video call coming in.

8. The method for leaving video messages on a terminal of claim 7, wherein: the step of performing a video message configuration on a video terminal comprises: the video terminal opening a video message setting module to perform the video message configuration, wherein the video message configuration comprises at least one of following: configuring whether to start the video message or not; carrying out configuration to start up for all incoming calls, a group of the incoming calls, a part of the incoming calls, or a certain incoming call number; carrying out configuration to start up for all incoming calls, a group of the incoming calls, a part of the incoming calls, or a certain incoming call number during a certain period of time; carrying out configuration to start up immediately when a call comes in, or to delay a period of time to start up when the video terminal doesn't answer proactively; configuring a prompt file of starting the video message and a prompt audio and video file when message time expires; configuring a maximum time length of a message; configuring whether to store in a mobile phone's own storage or to store in an extended storage card.

9. The method for leaving video messages on a terminal of claim 7, wherein: when the terminal has a call control module, the method further comprises: the call control module detecting the video call, and starting a video message function when the video call comes in and preset conditions are all met.

10. The method for leaving video messages on a terminal of claim 9, wherein the method further comprises: the call control module transmitting a message to a video reception and storage module of the terminal to store an audio and video file when detecting that a call ends.
